(19) United States
(12) Patent Application Publication
(10) Pub. No.: US 2025/0145512 A1
(43) Pub. Date: May 8, 2025

(54) METHODS AND APPARATUS FOR MANUFACTURING A RIBBON

(71) Applicant: CORNING INCORPORATED, CORNING, NY (US)

(72) Inventors: STEPHEN RAY HOWARD, LAWRENCEBURG, KY (US); JUI-HSIANG HUNG, PINE BROOK, NJ (US); JACOB IMMERMAN, CORNING, NY (US); WILLIAM EDWARD LOCK, HORSEHEADS, NY (US); ANIELLO MARIO PALUMBO, PAINTED POST, NY (US); DAVID POSADA-PINEDA, ELMIRA, NY (US); ROHIT RAI, PAINTED POST, NY (US); ZHEMING ZHENG, HORSEHEADS, NY (US)

(21) Appl. No.: 18/838,439

(22) PCT Filed: Feb. 27, 2023
(86) PCT No.: PCT/US2023/013920

§ 371 Date: Aug. 14, 2024

Related U.S. Application Data
(60) Provisional application No. 63/314,657, filed on Feb. 28, 2022.

(51) Int. Cl. C03B 13/08; C03B 13/16

(52) U.S. Cl. CPC C03B 13/08; C03B 13/16

(57) ABSTRACT

A glass manufacturing apparatus includes a delivery apparatus defining an upstream portion of a ribbon travel path extending in a first travel direction. A forming roll extends along an axis parallel to the travel path and perpendicular to the first travel direction. The forming roll includes a recess that imparts a protrusion to a ribbon. A substantially planar surface is positioned downstream from the forming roll and receives the ribbon. A conveyor supports the substantially planar surface. The conveyor moves the substantially planar surface in a second travel direction that is angled relative to the first travel direction. A force application apparatus biases the ribbon toward the substantially planar surface to alter a position of the protrusion relative to a major surface of the ribbon. Methods of manufacturing a ribbon are provided.

### CROSS-REFERENCE TO RELATED APPLICATION

This application claims the benefit of priority under 35 U.S.C. § 119 of U.S. Provisional Application Ser. No. 63/314,657 filed on Feb. 28, 2022, the content of which is relied upon and incorporated herein by reference in its entirety.

### FIELD

The present disclosure relates generally to methods for manufacturing a ribbon and, more particularly, to methods for manufacturing a ribbon with a glass manufacturing apparatus comprising a force application apparatus.

### BACKGROUND

It is known to manufacture molten material into a ribbon with a glass manufacturing apparatus. A pair of forming rolls can be spaced apart to define a gap that can receive the molten material. The molten material can pass through the gap, whereupon the molten material can be flattened into a ribbon. A shape can be imparted to the ribbon. However, as a result of the forming process, a stress and/or a warp of the ribbon may fall outside of a desirable range. In addition, there are limitations on the shape that may be imparted to the ribbon by this process.

### SUMMARY

The following presents a simplified summary of the disclosure to provide a basic understanding of some aspects described in the detailed description.

There are set forth methods of manufacturing a ribbon, for example, a glass ribbon, comprising introducing a stream of molten material along a travel path in a travel direction to a gap defined between a first forming roll and a second forming roll, and passing the stream of molten glass through the gap to form the ribbon. A protrusion can be formed in the ribbon by contacting the stream of molten material with a recess of the first forming roll. As a result of the forming process, defects may be present in the glass ribbon, for example, stress that is outside of a desirable range and warp that causes the glass ribbon to not be planar. To address these issues, the glass ribbon can be treated downstream from the forming rolls. For example, in some aspects, the ribbon can be planarized by being positioned on a substantially planar conveyor surface. To further facilitate the planarization of the ribbon, a force can be applied to the ribbon to bias the ribbon toward the substantially planar conveyor surface. In aspects, the force can be applied by a vacuum or a press. In addition, a temperature of the ribbon can be controlled, which can facilitate a reduction in stress and warp. The temperature can be controlled by controlling a temperature of the substantially planar conveyor surface or by altering a temperature of a turning roll. The ribbon can be delivered to a cooling apparatus, wherein the ribbon can be gradually cooled. A temperature difference between portions of the ribbon can be controlled, both prior to the ribbon reaching the cooling apparatus and within the cooling apparatus. By controlling the temperature difference, stress and warp can further be reduced as the ribbon is cooled within the cooling apparatus.

Aspect 1. A glass manufacturing apparatus comprising:
a delivery apparatus defining an upstream portion of a ribbon travel path extending in a first travel direction;
a forming roll extending along an axis that is parallel to the travel path and perpendicular to the first travel direction, the forming roll comprising a recess configured to impart a protrusion to a ribbon traveling along the ribbon travel path in the first travel direction;
a substantially planar surface positioned downstream from the forming roll and configured to receive the ribbon;
a conveyor supporting the substantially planar surface, the conveyor configured to move the substantially planar surface in a second travel direction that is angled relative to the first travel direction; and
a force application apparatus configured to bias the ribbon toward the substantially planar surface to alter a position of the protrusion relative to a major surface of the ribbon.

Aspect 2. The glass manufacturing apparatus of aspect 1, wherein the force application apparatus comprises a vacuum apparatus in fluid communication with an opening in the substantially planar surface, the vacuum apparatus configured to evacuate air from the opening.

Aspect 3. The glass manufacturing apparatus of aspect 1, wherein the force application apparatus comprises one or more presses spaced apart from the substantially planar surface to define a gap through which the ribbon travels, the one or more presses configured to move in a direction toward the substantially planar surface and contact the ribbon.

Aspect 4. The glass manufacturing apparatus of aspect 3, wherein the one or more presses are configured to move in the second travel direction at a velocity that is substantially equal to a velocity of the substantially planar surface.

Aspect 5. The glass manufacturing apparatus of any one of aspects 1-4, wherein the conveyor comprises a second substantially planar surface positioned upstream from the substantially planar surface, the second substantially planar surface forming an angle relative to the substantially planar surface that is within a range from about 135 degrees to about 175 degrees.

Aspect 6. The glass manufacturing apparatus of any one of claims 1-5, wherein the conveyor comprises a thermal management apparatus configured to alter a temperature of the substantially planar surface.

Aspect 7. Methods of manufacturing a ribbon comprising:
contacting the ribbon with a recess of a forming roll to impart a protrusion to the ribbon traveling along a ribbon travel path in a first travel direction;
receiving the ribbon on a surface positioned downstream from the forming roll; and then
altering a position of the protrusion relative to a major surface of the ribbon.

Aspect 8. Methods of aspect 7, wherein the altering the position comprises forming a vacuum between the ribbon and the surface to bias the ribbon toward the surface.

Aspect 9. Methods of aspect 7, wherein the altering the position comprises moving a press in a first direction toward the surface and contacting the ribbon to bias the ribbon toward the surface.

Aspect 10. Methods of aspect 9, further comprising moving the press and the ribbon in a second travel direction at a substantially equal velocity.

Aspect 11. Methods of any one of aspects 9-10, further comprising moving a second press in a second direction that is opposite the first direction and contacting the ribbon such that the ribbon is in contact with the press and the second press.

Aspect 12. Methods of any one of aspects 7-11, further comprising activating a thermal management apparatus that controls a temperature of the surface to reduce a temperature of the ribbon as the ribbon is in contact with the surface.

Aspect 13. Methods of any one of claims 7-12, further comprising turning the ribbon around a turning roll after imparting the protrusion and before receiving the ribbon on the surface, the turning roll altering a temperature of the ribbon

Aspect 14. Methods of manufacturing a ribbon comprising:
contacting the ribbon with a recess of a forming roll to impart a protrusion to the ribbon traveling along a ribbon travel path in a first travel direction;
reducing a temperature difference between the protrusion and a major surface of the ribbon to less than about 5° C. as the ribbon reaches an inlet of a cooling apparatus;
passing the ribbon through the inlet, the ribbon comprising a viscosity within a range from about 10⁹ poise to about 10¹³ poise;
changing a temperature of the protrusion within an interior of the cooling apparatus while maintaining the temperature difference between the protrusion and the surrounding portion of the ribbon to less than about 5° C.; and
passing the ribbon through an exit of the cooling apparatus, the ribbon comprising a viscosity upon exiting that is greater than about 10¹⁶ poise.

Aspect 15. Methods of aspect 14, further comprising changing a temperature of the major surface within the interior of the cooling apparatus while maintaining the temperature difference between the protrusion and the surrounding portion of the ribbon to less than about 5° C.

Aspect 16. Methods of any one of aspects 14-15, wherein the ribbon comprises an inlet temperature that is below a setting temperature of the ribbon and is within a range from about 620° C. to about 725° C.

Aspect 17. Methods of any one of aspects 14-16, wherein the ribbon comprises a temperature upon exiting that is within a range from about 540° C. to about 560° C.

Aspect 18. Methods of any one of aspects 14-17, further comprising:
receiving the ribbon on a surface positioned downstream from the forming roll, the surface moving in a second travel direction that is angled relative to the first travel direction; and
altering a position of the protrusion relative to the major surface of the ribbon.

Aspect 19. Methods of aspect 18, wherein the altering the position comprises forming a vacuum between the ribbon and the surface to bias the ribbon toward the surface.

Aspect 20. Methods of aspect 18, wherein the altering the position comprises moving a press in a direction toward the surface and contacting the ribbon to bias the ribbon toward the surface.

Additional features and advantages of the aspects disclosed herein will be set forth in the detailed description that follows, and in part will be clear to those skilled in the art from that description or recognized by practicing the aspects described herein, including the detailed description which follows, the claims, as well as the appended drawings. It is to be understood that both the foregoing general description and the following detailed description present aspects intended to provide an overview or framework for understanding the nature and character of the aspects disclosed herein. The accompanying drawings are included to provide further understanding and are incorporated into and constitute a part of this specification. The drawings illustrate various aspects of the disclosure, and together with the description explain the principles and operations thereof.

### BRIEF DESCRIPTION OF THE DRAWINGS

These and other features, aspects and advantages are better understood when the following detailed description is read with reference to the accompanying drawings, in which:

FIG. 1 schematically illustrates example aspects of a glass manufacturing apparatus in accordance with aspects of the disclosure;

FIG. 2 illustrates a perspective view of example aspects of a ribbon supported by a support surface in accordance with aspects of the disclosure;

FIG. 3 illustrates a side view of example aspects of a support surface supporting the ribbon in accordance with aspects of the disclosure;

FIG. 4 illustrates a side view of example aspects of a force application apparatus and a support surface supporting the ribbon in accordance with aspects of the disclosure;

FIG. 5 illustrates a side view of example aspects of a force application apparatus and a support surface supporting the ribbon in accordance with aspects of the disclosure;

FIG. 6 illustrates a side view of a portion of the force application apparatus in accordance with aspects of the disclosure;

FIG. 7 illustrates a side view of example aspects of a force application apparatus and a support surface supporting the ribbon in accordance with aspects of the disclosure;

FIG. 8 illustrates a side view of example aspects of a plurality of force application apparatuses and a support surface supporting the ribbon in accordance with aspects of the disclosure;

FIG. 9 illustrates a side view of example aspects of a turning roll in accordance with aspects of the disclosure;

FIG. 10 illustrates a side view of example aspects of the ribbon entering a cooling apparatus in accordance with aspects of the disclosure;

FIG. 11 illustrates a side view of example aspects of the ribbon within the cooling apparatus in accordance with aspects of the disclosure; and

FIG. 12 illustrates a side view of example aspects of the ribbon exiting the cooling apparatus in accordance with aspects of the disclosure.

### DETAILED DESCRIPTION

Aspects will now be described more fully hereinafter with reference to the accompanying drawings in which example aspects are shown. Whenever possible, the same reference numerals are used throughout the drawings to refer to the same or like parts. However, this disclosure may be embodied in many different forms and should not be construed as limited to the aspects set forth herein.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, aspects include from the one value to the other value. Similarly, when values are expressed as approximations by use of the antecedent “about,” it will be understood that the value forms another aspect. It will be further understood that the endpoints of each of the ranges are significant both in relation to the other endpoint, and independently of the other endpoint.

Directional terms as used herein-for example up, down, right, left, front, back, top, bottom, upper, lower, etc.-are made only with reference to the figures as drawn and are not intended to imply absolute orientation.

Unless otherwise expressly stated, it is in no way intended that any methods set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic relative to arrangement of steps, operational flow, order of components, or orientation of components; plain meaning derived from grammatical organization or punctuation, and; the number or type of aspects described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. The term “substantially” may denote values within about 10% of each other, for example, within about 5% of each other, or within about 2% of each other.

Modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first end and a second end generally correspond to end A and end B or two different ends.

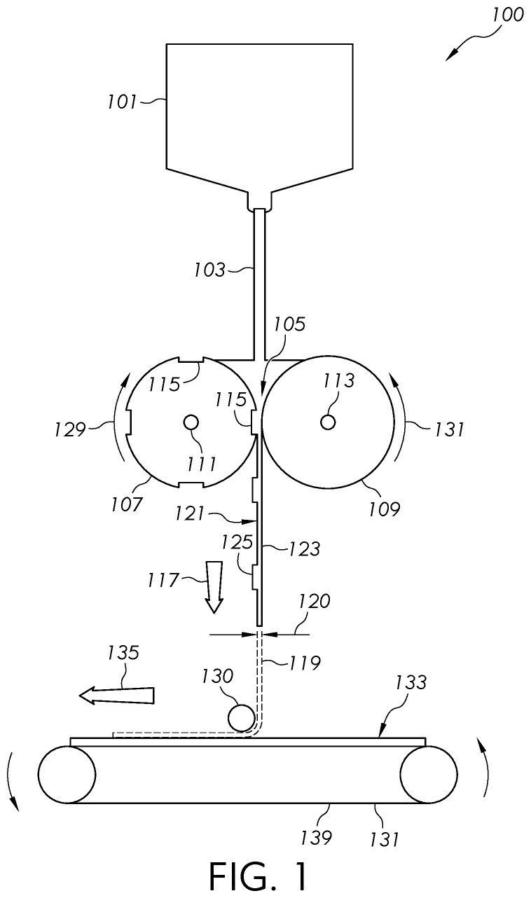

The present disclosure relates to a glass manufacturing apparatus and methods for forming a ribbon. For purposes of this application, a “ribbon” may be considered one or more of a ribbon in a viscous state, a ribbon in an elastic state (e.g., at room temperature) and/or a ribbon in a viscoelastic state between the viscous state and the elastic state. The ribbon may comprise a ribbon of an indeterminate length or one or more separated glass articles (e.g., separated ribbons, separated sheets, etc.) that comprise four discrete edges. Methods and apparatus for manufacturing a ribbon will now be described by way of example aspects. As schematically illustrated in FIG. 1, in aspects, an exemplary glass manufacturing apparatus 100 can comprise a delivery apparatus 101 with a delivery conduit through which a stream of molten material 103 (e.g., molten glass) can exit the delivery apparatus 101. For example, the delivery apparatus 101 can comprise an elongated passageway with an opening at the end of the delivery apparatus 101. In aspects, the delivery apparatus 101 can be oriented along a direction of gravity, such that the stream of molten material 103 can flow downwardly along the direction of gravity from the delivery apparatus 101.

The delivery apparatus 101 can convey the stream of molten material 103 along a ribbon travel path 119 extending in a first travel direction 117 (e.g., by defining an upstream portion of the ribbon travel path 119). In aspects, the glass manufacturing apparatus 100 can comprise one or more pairs of opposing forming rolls, for example, a first forming roll 107 and a second forming roll 109. The second forming roll 109 may be spaced from the first forming roll 107 to define a gap 105. The gap 105 provides a ribbon 123 with a width and a thickness 120. In aspects, the first forming roll 107 and the second forming roll 109 can rotate counter to one another. For example, in the orientation shown in FIG. 1, the first forming roll 107 can rotate in a clockwise direction while the second forming roll 109 can rotate in a counter-clockwise direction. In aspects, the first forming roll 107 and the second forming roll 109 can receive the stream of molten material 103 along the travel path 119 within the gap 105. The stream of molten material 103 can accumulate between the first forming roll 107 and the second forming roll 109, whereupon the first forming roll 107 and the second forming roll 109 can flatten, thin, and smooth the stream of molten material 103 into the ribbon 123.

The first forming roll 107 can extend along an axis 111 that is parallel to the travel path 119 and perpendicular to the first travel direction 117. The second forming roll 109 can extend along an axis 113 that is parallel to the travel path 119 and perpendicular to the first travel direction 117. In aspects, one or more of the first forming roll 107 or the second forming roll 109 can comprise a textured feature that may impart a corresponding textured feature to the ribbon 123. For example, in aspects, the textured feature of the forming roll(s) 107, 109 can comprise, for example, projections (e.g., extensions, outcroppings, etc.), recesses (e.g., openings, channels, etc.). As illustrated and described relative to FIG. 1, the textured feature of the first forming roll 107 can comprise a recess 115 that can impart a protrusion 125 to the ribbon 123 traveling along the ribbon travel path 119 in the first travel direction 117. The recess 115 can be formed at an outer surface of the first forming roll 107. For example, the first forming roll 107 can comprise a substantially circular cross-sectional shape. Accordingly, a radial distance from a center of the first forming roll 107 to the recess 115 may be less than a radial distance from a center of the first forming roll 107 to the outer surface of the first forming roll 107 at a location of the first forming roll 107 at which the recess 115 is not present. In aspects, additional recesses 115 can be spaced apart about a circumference of the first forming roll 107. In addition, or in the alternative, additional recesses can be located at differing locations about the axis 111 (e.g., which goes through the center of the first forming roll 107) of the first forming roll 107. In aspects, the recess 115 may extend around a full circumference of the first forming roll 107 to create a region of larger thickness in the ribbon 123 that is continuous in the travel direction of the ribbon (e.g., a strip of larger thickness).

In aspects, the recess 115 can impart a corresponding textured feature, for example, the protrusion 125, to the ribbon 123. For example, as the stream of molten material 103 travels through the gap 105, the stream of molten material 103 can contact the first forming roll 107 and the second forming roll 109 such that the ribbon 123 can be formed and may exit the gap 105. In aspects, the contact between the first forming roll 107 and the ribbon 123 can impart the corresponding textured feature, for example, the protrusion 125, to the ribbon 123. The ribbon 123 can contact the first forming roll 107 and may engage the recess 115, for example, by flowing into the recess 115. As a result, the recess 115 can cause a corresponding protrusion 125 in a first major surface 121 of the ribbon 123. The protrusion 125 may comprise a thicker area of the ribbon 123 as compared to locations immediately upstream and downstream from the protrusion 125. Accordingly, in aspects, methods of manufacturing the ribbon 123 can comprise contacting the ribbon 123 with the recess 115 of the first forming roll 107 to impart the protrusion 125 to the ribbon 123 traveling along the ribbon travel path 119 in the first travel direction 117. In aspects, the thickness may be continuous in the first travel direction 117 and may vary only in the across-the-travel direction such that a continuous strip of larger thickness in the first travel direction 117 may be formed.

In aspects, additional rollers may be located downstream from the first forming roll 107 and the second forming roll 109 relative to the first travel direction 117. For example, a turning roll 130 may be located downstream from the forming rolls 107, 109 relative to the first travel direction 117 to change the travel direction of the travel path 119. For example, the turning roll 130 can direct the ribbon 123 to turn about 90 degrees such that the ribbon 123 can move from a substantially vertical orientation upstream from the turning roll 130 to a horizontal orientation downstream from the turning roll 130.

In aspects, a conveyor 131 can support a substantially planar surface 133 upon which the ribbon 123 is received. The conveyor 131 can move the substantially planar surface 133 in a second travel direction 135 that is angled relative to the first travel direction 117. The substantially planar surface 133 may be positioned downstream from the forming rolls 107, 109 and downstream from the turning roll 130 relative to the first travel direction 117 and the second travel direction 135 of the ribbon 123. In aspects, the conveyor 131 can comprise a belt conveyor apparatus (e.g., a belt conveyor) in which the conveyor 131 comprises two or more pulleys with a conveyor belt 139 or other endless loop carrying apparatus rotating about the pulleys. In aspects, one or more of the pulleys may be powered, thus moving the conveyor belt 139 and the surface 133.

In aspects, the second travel direction 135 may form an angle relative to the first travel direction 117. For example, the second travel direction 135 can comprise the direction along which the surface 133 moves when the surface 133 receives the ribbon 123. Accordingly, in aspects, when the surface 133 is in a position to receive the ribbon 123, for example, by being located along a top side or top surface of the conveyor 131 that faces the turning roll 130, the surface 133 can move in the second travel direction 135 away from the turning roll 130. In aspects, the second travel direction 135 can form an angle relative to the first travel direction 117 that may be within a range from about 1° to about 179°, or within a range from about 45° to about 135°, or within a range from about 60° to about 120°, or within a range from about 85° to about 95°. In the illustrated aspects of FIG. 1, the second travel direction 135 can form an angle relative to the first travel direction 117 that is about 90° (e.g., by being substantially perpendicular to the first travel direction 117). Accordingly, methods of manufacturing the ribbon 123 can comprise receiving the ribbon 123 on the surface 133 positioned downstream from the first forming roll 107.

In aspects, the ribbon 123 may comprise glass (e.g., a glass substrate or a glass ribbon), for example, one or more of soda-lime glass, borosilicate glass, alumino-borosilicate glass, alkali-containing glass, alkali-free glass, aluminosilicate, borosilicate, boroaluminosilicate, silicate, glass-ceramic, or other materials comprising glass. In aspects, the ribbon 123 can comprise one or more of lithium fluoride (LiF), magnesium fluoride (MgF₂), calcium fluoride (CaF₂), barium fluoride (BaF₂), sapphire (Al₂O₃), zinc selenide (ZnSe), germanium (Ge) or other materials. The ribbon 123 can alternatively comprise a ceramic, polymer, metal, multi-layer stack, or a composite of materials. The ribbon 123 can comprise several shapes, for example, square shapes, rectangular shapes, hexagonal shapes, irregular shapes, etc. In aspects, the ribbon 123 can be employed in a variety of display and non-display applications comprising, but not limited to, liquid crystal displays (LCDs), electrophoretic displays (EPD), organic light emitting diode displays (OLEDs), plasma display panels (PDPs), microLED displays, miniLED displays, organic light emitting diode lighting, light emitting diode lighting, augmented reality (AR), virtual reality (VR), touch sensors, photovoltaics, foldable phones, or other applications.

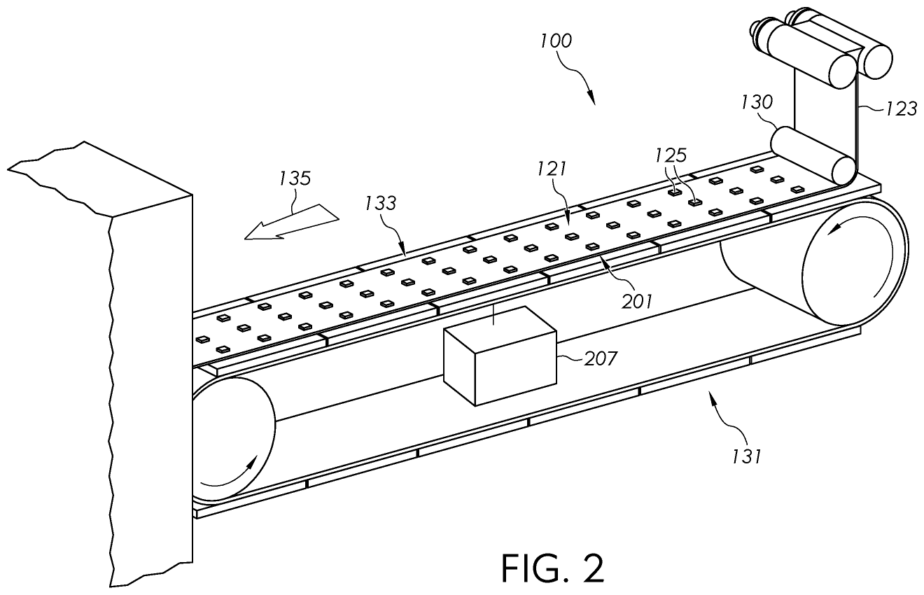

FIG. 2 illustrates a perspective view of the glass manufacturing apparatus 100 as the ribbon 123 is received on the surface 133. In aspects, the ribbon 123 comprises a plurality of protrusions 125 that are formed on the first major surface 121 by the plurality of recesses 115 in the first forming roll 107. For example, the protrusions 125 and the first major surface 121 can face away from the surface 133 such that the protrusions 125 and the first major surface 121 may not be in contact with the surface 133 while an opposing second major surface 201 of the ribbon 123 can be in contact with the surface 133. In aspects, following the formation of the protrusions 125, portions of the ribbon 123 may experience warp, for example, with the second major surface 201 no longer being planar. To reduce warp of the ribbon 123 and increase the planarity of the second major surface 201, the surface 133 may be substantially planar such that the ribbon 123 may be drawn into the surface 133 due to the force of gravity acting upon the ribbon 123. In aspects, the substantially planar surface 133 can function to reduce non-planar portions of the second major surface 201.

In aspects, the conveyor 131 can comprise a thermal management apparatus 207 that can alter (e.g., control) a temperature of the substantially planar surface 133. For example, the thermal management apparatus 207 can be in operative association with the surface 133 such that the thermal management apparatus 207 can increase or decrease a temperature of the surface 133. In aspects, the thermal management apparatus 207 can comprise a heater, for example, an electrical resistance heater that can be electrically connected to the surface 133 and heat the surface 133 by resistance heating, such that the thermal management apparatus 207 can alter the temperature of the substantially planar surface 133 by heating the substantially planar surface 133. In aspects, the thermal management apparatus 207 can comprise a blower that can blow air toward the surface 133 (e.g., by being positioned below the surface 133) and alter a temperature of the surface 133 (e.g., by cooling the surface 133). By controlling the temperature of the surface 133, a temperature of the ribbon 123 can likewise be controlled. For example, as the ribbon 123 travels in the second travel direction 135 from the turning roll 130, a temperature of the ribbon 123 may change due to being exposed to a surrounding air temperature. Controlling the temperature of the ribbon 123 can allow for a stress of the ribbon 123 to be maintained within a desired stress range. Accordingly, methods can comprise activating the thermal management apparatus 207 that controls a temperature of the surface 133 to alter (e.g., reduce or increase) a temperature of the ribbon 123 as the ribbon 123 is in contact with the surface 133. In aspects, the activating can comprise initiating a heater that can heat and/or maintain a temperature of the surface 133. In aspects, the conveyor 131 can comprise cooling tools such that different portions of the ribbon 123 can be heated or cooled. As such, heating (e.g., or cooling) of the ribbon 123 may be done directionally, for example, by adding heaters or cooling tools on the side opposite to the surface 133 (e.g., facing the first major surface 121).

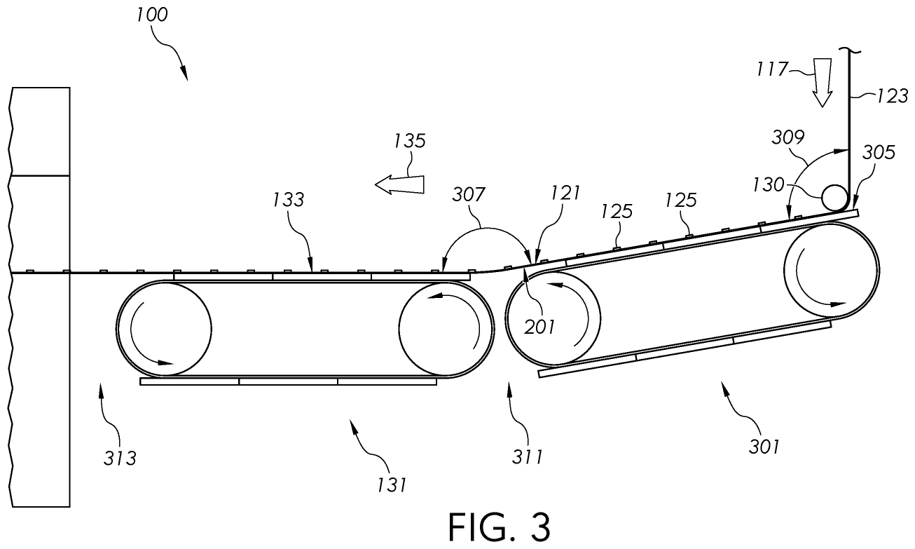

FIG. 3 illustrates a perspective view of the glass manufacturing apparatus 100 comprising a plurality of substantially planar surfaces downstream from the turning roll 130. For example, in aspects, the glass manufacturing apparatus 100 can comprise the conveyor 131 and a second conveyor 301 that are spaced apart along the second travel direction 135. The second conveyor 301 can be substantially similar in structure and function to the conveyor 131. For example, the second conveyor 301 can be positioned downstream from the turning roll 130 relative to the second travel direction 135 and upstream from the conveyor 131. As such, the ribbon 123 can reach the second conveyor 301 after passing the turning roll 130, followed by reaching the conveyor 131. In aspects the second conveyor 301 can comprise a second substantially planar surface 305 that is substantially similar to the surface 133 of the conveyor 131. For example, the second substantially planar surface 305 can receive the ribbon 123 and move the ribbon 123 in the second travel direction 135 toward the conveyor 131. As such, the second conveyor 301 can comprise the second substantially planar surface 305 that may be positioned upstream from the substantially planar surface 133.

In aspects, the second substantially planar surface 305 may form an angle 307 relative to the substantially planar surface 133 that may be within a range from about 135 degrees to about 175 degrees. For example, the second substantially planar surface 305 may be non-parallel relative to the surface 133 such that the ribbon 123 may undergo a more gradual change in direction from a vertical orientation (e.g., upstream from the turning roll 130) to a horizontal orientation (e.g., at the surface 133) than as illustrated in FIG. 2. For example, as the ribbon 123 is conveyed around the turning roll 130, the ribbon 123 may undergo a bend from the vertical orientation (e.g., upstream from the turning roll 130) to a non-vertical orientation (e.g., at the second substantially planar surface 305). In aspects, a second angle 309 may be formed between the vertical orientation and the non-vertical orientation, in which the second angle 309 may be within a range from about 100 degrees to about 135 degrees. The second angle 309 may form a more gradual bend of the ribbon 123 as compared to FIG. 2, wherein the ribbon 123 forms a substantially 90 degree bend from a location upstream of the turning roll 130 to a location downstream of the turning roll 130 at the surface 133. By forming the more gradual bend in FIG. 3, the ribbon 123 may experience a reduced amount of stress and/or warp upon reaching the second substantially planar surface 305. In aspects, to provide further support to the ribbon 123, additional supporting structures (e.g., air bearing bars) may be provided between the conveyors 131, 301 and/or downstream from the conveyor 131. In aspects, the supporting structures can be positioned upstream (e.g., at a first location 311) and/or downstream (e.g., at a second location 313) from the conveyor 131.

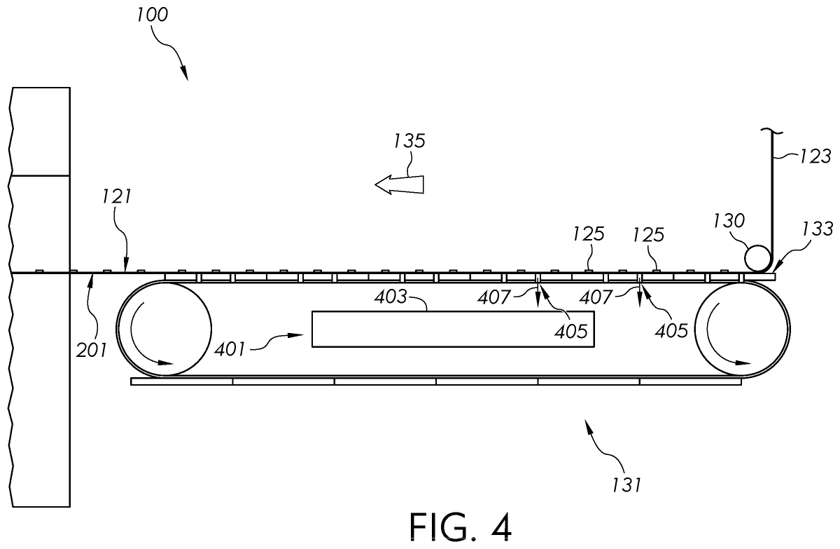

FIG. 4 illustrates a side view of the glass manufacturing apparatus 100 comprising a force application apparatus 401 that can bias the ribbon 123 toward the substantially planar surface 133 to alter a position of the protrusion 125 relative to the first major surface 121 of the ribbon 123. In aspects, the force application apparatus 401 can be positioned within the conveyor 131 between the pulleys. While a single conveyor (e.g., conveyor 131) is illustrated in FIG. 4, the glass manufacturing apparatus 100 can comprise a plurality of conveyors 131, 301 similar to FIG. 3 with a plurality of force application apparatuses positioned within the conveyors 131, 301. In aspects, the force application apparatus 401 can comprise a vacuum apparatus 403 that can draw gas through the surface 133. For example, the vacuum apparatus 403 may be contained within a sealed volume and the surface 133 can comprise one or more openings 405 that pass through the surface 133 between a first side and a second side of the surface 133. The vacuum apparatus 403 may be in fluid communication with the one or more openings 405 in the substantially planar surface 133. The vacuum apparatus 403 can draw air 407 through the one or more openings 405 toward the vacuum apparatus 403. In aspects, the ribbon 123 can be positioned on the surface 133, such that the ribbon 123 may be located on one side of the surface 133 and the vacuum apparatus 403 may be located on an opposing side of the surface 133.

In aspects, methods can comprise altering a position of the protrusion 125 relative to a major surface (e.g., the first major surface 121) of the ribbon 123. For example, the ribbon 123 can rest upon and be in contact with the surface 133, such that the ribbon 123 can cover the one or more openings 405. Altering the position of the protrusion 125 can comprise forming a vacuum between the ribbon 123 and the surface 133 to bias the ribbon 123 toward the surface 133. For example, the vacuum apparatus 403 can draw air 407 through the one or more openings 405 toward the vacuum apparatus 403. By drawing air through the one or more openings 405, the vacuum apparatus 403 can bias the second major surface 201 of the ribbon 123 toward the surface 133. Due to the surface 133 comprising the substantially planar shape, the ribbon 123 may be flattened as the second major surface 201 is biased toward the surface 133. As such, portions of the ribbon 123 that are initially non-planar upon being received on the surface 133 may be flattened as the ribbon 123 travels in the second travel direction 135 from one end of the conveyor 131 to an opposing end of the conveyor 131. Accordingly, the protrusion 125 may not be affected by the vacuum apparatus 403 but, rather, portions of the ribbon 123 surrounding the protrusion 125 (e.g., the first major surface 121) may be flattened such that the presence of warp in the ribbon 123 and/or the presence of non-planar areas at the second major surface 201 may be reduced. In particular, a location of the protrusion 125 and/or the top of the protrusion 125 may not be affected, but, rather, the portion of the protrusion 125 that forms part of the second major surface 201 (e.g., that lies within a footprint of the protrusion 125) may be planarized and made co-planar with the surrounding portions of the second major surface 201 (e.g., that lie outside of a footprint of the protrusion 125). In aspects, the non-planarity of the second major surface 201 may be due to the weight of the protrusion 125, such that the protrusion 125 may sag (e.g., back-protrusion). The vacuum apparatus 403 can planarize the second major surface 201 while the ribbon 123 is at a viscosity that allows the ribbon 123 to change shape.

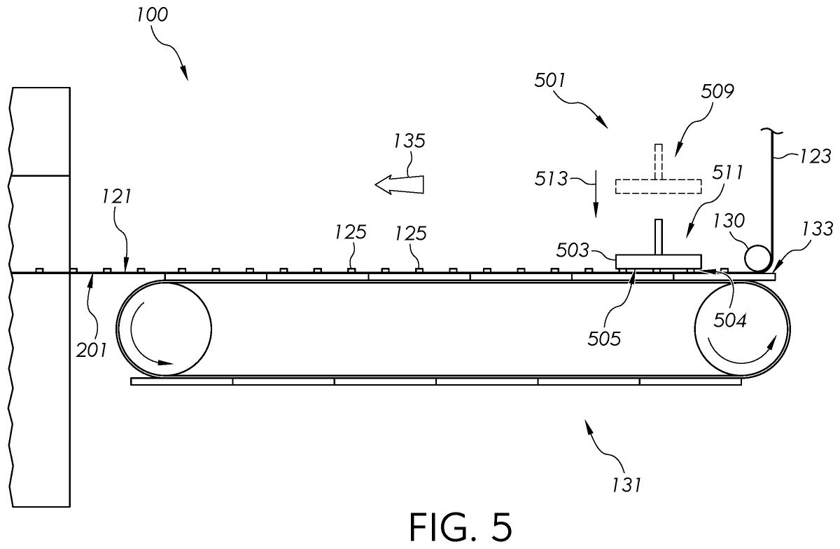

FIG. 5 illustrates a side view of the glass manufacturing apparatus 100 comprising a force application apparatus 501 that can bias the ribbon 123 toward the substantially planar surface 133 to alter a position of the protrusion 125 relative to the first major surface 121 of the ribbon 123. In aspects, the force application apparatus 501 can comprise one or more presses, for example, a press 503 that may be spaced apart from the substantially planar surface 133 to define a gap 504 through which the ribbon 123 can travel. The press 503 can move in a first direction 513 toward the substantially planar surface 133 and contact the ribbon 123. For example, the press 503 can comprise a press surface 505 that contacts a portion of the ribbon 123. In aspects, the press surface 505 may be substantially planar and can be oriented to be substantially parallel to the first major surface 121 of the ribbon 123, and the press surface 505 may be substantially parallel to the surface 133. The gap 504 may be due to the height of the protrusion 125 such that, in aspects, the press surface 505 may contact the top of the protrusion 125, thus planarizing the top of the protrusion 125.

In aspects, methods can comprise altering a position of the protrusion 125 relative to a major surface (e.g., the first major surface 121) of the ribbon 123, wherein altering the position can comprise moving the press 503 in the first direction 513 toward the surface 133 and contacting the ribbon 123 to bias the ribbon 123 toward the surface 133. For example, the press 503 can initially be in a first position 509 and can be moved to a second position 511 by moving in the first direction 513. In the first position 509, the press 503 can be spaced apart from the first major surface 121 and the protrusions 125 of the ribbon 123, such that the press surface 505 may not be in contact with the first major surface 121 or the protrusions 125. In aspects, the press 503 can move in the first direction 513, wherein the first direction 513 is substantially perpendicular to the second travel direction 135 of the ribbon 123. As such, by moving in the first direction 513, the press 503 can move toward the ribbon 123. The press 503 can continue to move in the first direction 513 from the first position 509 until the press 503 contacts the ribbon 123. For example, due to the press surface 505 comprising a substantially planar shape, the press surface 505 may contact the protrusions 125 and bias the ribbon 123 toward the surface 133.

Contacting the ribbon 123 with the press 503 can yield several benefits. For example, the press 503 can reduce warp in the ribbon 123 by biasing the ribbon 123 into contact with the substantially planar surface 133. Further, in aspects, prior to the press surface 505 contacting the protrusions 125, the protrusions 125 may comprise a non-constant height (e.g., measured from the second major surface 201 to a top of the protrusion 125), such that one protrusion 125 may comprise a different height than another protrusion 125. To reduce height variability between and within protrusions 125, the press surface 505 can contact the protrusions 125 and apply a force (e.g., or pressing could be position-controlled) to the protrusions 125 in the first direction 513. A distance between the press surface 505 and the surface 133 (e.g., spanning the gap 504) may be substantially constant when the press 503 is in the second position 511. As such, the force applied by the press 503 can reduce a height variation of the protrusions 125 such that the protrusions 125 may comprise substantially the same height following contact with the press surface 505. In addition, the press 503 can be maintained at a predetermined temperature such that the press surface 505 can change a temperature of the protrusions 125. For example, in aspects, the protrusions 125 may be at a higher temperature than other portions of the ribbon 123. To reduce a temperature of the protrusions 125 and a temperature disparity within the ribbon 123, the press surface 505 can be maintained at a lower temperature than the protrusions 125, such that contact between the press surface 505 and the protrusions 125 can reduce the temperature of the protrusions 125.

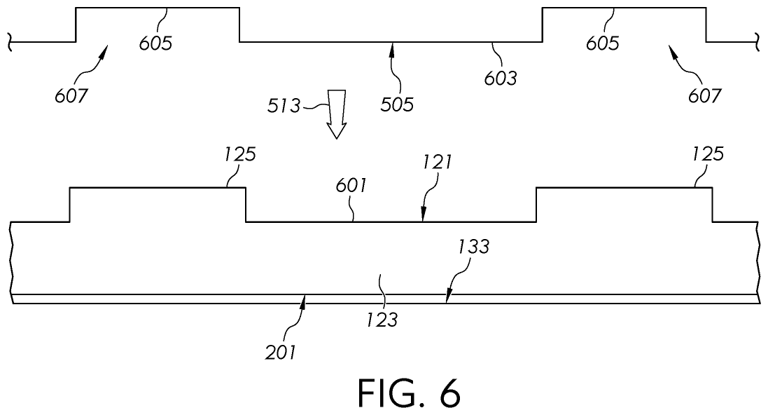

FIG. 6 illustrates a side view of additional aspects of the press surface 505. For example, while FIG. 5 illustrates the press surface 505 as comprising a substantially planar shape that contacts the protrusions 125 and not a base portion 601 of the first major surface 121, the press surface 505 is not limited to such a shape. Rather, in aspects, the press surface 505 can comprise a non-planar shape. For example, as illustrated in FIG. 6, the press surface 505 can comprise a first surface portion 603 and a second surface portion 605. In aspects, the first surface portion 603 and the second surface portion 605 can be substantially planar and may be parallel. The second surface portion 605 can form a boundary of a recess 607 at the press surface 505 such that the second surface portion 605 may not be co-planar with the first surface portion 603 but, rather, the first surface portion 603 and the second surface portion 605 may be offset from one another. In aspects, the base portion 601 of the ribbon 123 can comprise the portion of the first major surface 121 that extends between the protrusions 125. The base portion 601 may be substantially planar.

The press surface 505 can substantially match a shape of the first major surface 121, such that the first surface portion 603 and the second surface portion 605 of the press surface 505 can match a location, shape, and size of the protrusions 125 and the base portion 601. For example, the recess 607 can comprise a size and shape that substantially matches the size and shape of the protrusions 125. As such, when the press surface 505 is moved in the first direction 513 and contacts the ribbon 123, one of the protrusions 125 can be received within one of the recesses 607. A distance separating adjacent recesses 607 along the first surface portion 603 can substantially match a distance separating adjacent protrusions 125 along the base portion 601, such that the first surface portion 603 can contact the base portion 601 when the protrusions 125 are received within the recesses 607. In operation, the press surface 505 can be moved in the first direction 513 toward the first major surface 121. The protrusions 125 can be received within the recesses 607, with the second surface portion 605 contacting a top side of the protrusions 125. In aspects, the first surface portion 603 can contact the base portion 601. Together, the first surface portion 603 and the second surface portion 605 can apply a force to the first major surface 121, for example, the protrusions 125 and the base portion 601. This force can cause the base portion 601 and the top side of the protrusions 125 to flatten and planarize, thus reducing warp in the ribbon 123.

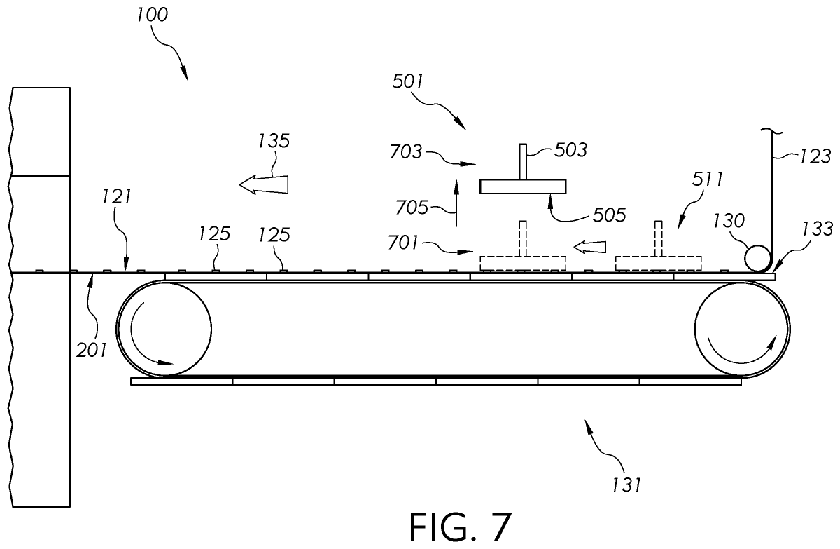

FIG. 7 illustrates a side view of the glass manufacturing apparatus 100 comprising the force application apparatus 501 after a period of time has passed following the movement of the press 503 from the first position 509 to the second position 511 (e.g., illustrated in FIG. 5). In aspects, the press 503 is not limited to moving in the first direction 513 of FIG. 5. Rather, the press 503 can be moved in the second travel direction 135 to accommodate the movement of the ribbon 123 by the surface 133. For example, the surface 133 may move continuously, such that the ribbon 123 may move continuously, before the press 503 contacts the ribbon 123 and as the press 503 contacts the ribbon 123. In aspects, methods can comprise moving the press 503 and the ribbon 123 in the second travel direction 135 at a substantially equal velocity. For example, the press 503 may initially contact the ribbon 123 when the press 503 is in the second position 511. Upon contacting the ribbon 123, the press 503 can be moved from the second position 511 to a third position 701. The third position 701 may be located downstream from the second position 511, with the press 503 remaining in contact with the ribbon 123 while moving in the second travel direction 135 from the second position 511 to the third position 701. In aspects, as the press 503 moves in the second travel direction 135, the press 503 may not move closer to or farther from the ribbon 123, such that the distance separating the press surface 505 and the ribbon 123 may remain the same. The press surface 505 may be substantially parallel to the surface 133 (e.g., with the surface portions 603, 605 substantially parallel to the surface 133). By moving in the second travel direction 135, the press 503 can apply the force to flatten and/or planarize portions of the ribbon 123 without stopping movement of the ribbon 123 in the second travel direction 135. Rather, the press 503 and the ribbon 123 can move at substantially the same velocity such that a relative velocity between the press 503 and the ribbon 123 may be about zero. The press 503 can alter a position of the protrusion 125 relative to a major surface (e.g., the first major surface 121) of the ribbon 123, wherein altering the position can comprise moving the press 503 in the first direction 513 toward the surface 133 and contacting the ribbon 123 to bias the ribbon 123 toward the surface 133.

In aspects, after the press 503 has moved a predetermined distance from the second position 511 to the third position 701 in the second travel direction 135, the press 503 may be moved out of contact with the ribbon 123. For example, in the third position 701, the press surface 505 may be in contact with at least portions of the first major surface 121. The press 503 can be moved in a second direction 705 that is opposite the first direction 513 (e.g., illustrated in FIG. 5). For example, the second direction 705 may be substantially perpendicular to the second travel direction 135 of the ribbon 123 and may be away from the ribbon 123. In aspects, the press 503 can move between the third position 701 and the fourth position 703 along an axis that is substantially perpendicular to the first major surface 121. By moving in the second direction 705, the press 503 can move away from the ribbon 123 and out of contact with portions of the first major surface 121. Upon reaching the fourth position 703, the press can return to the first position 509 and begin the operation of contacting portions of the first major surface 121 by moving from the first position 509 to the fourth position 703 again.

While FIGS. 5 and 7 illustrate the glass manufacturing apparatus 100 comprising a single press 503, in aspects, the glass manufacturing apparatus 100 can comprise a plurality of presses, wherein the other presses may be substantially similar to the press 503 illustrated in FIGS. 5-7. For example, by providing a plurality of presses, the presses can contact substantially all portions of the first major surface 121 while limiting the likelihood that portions of the first major surface 121 may not be contacted by a press. In aspects, when the press 503 is in one of the first position 509 or the second position 511, a second press can be in one of the third position 701 or the fourth position 703. As such, the presses may not interfere with one another when moving between the positions 509, 511, 701, 703 while still contacting portions of the first major surface 121 and limiting the likelihood of portions of the first major surface 121 not being contacted by a press. As such, the glass manufacturing apparatus 100 is not limited to comprising the single press 503, but can comprise one or more presses 503 that may function similarly to the press 503 by moving between the positions 509, 511, 701, 703 in the directions 513, 135, 705, etc.

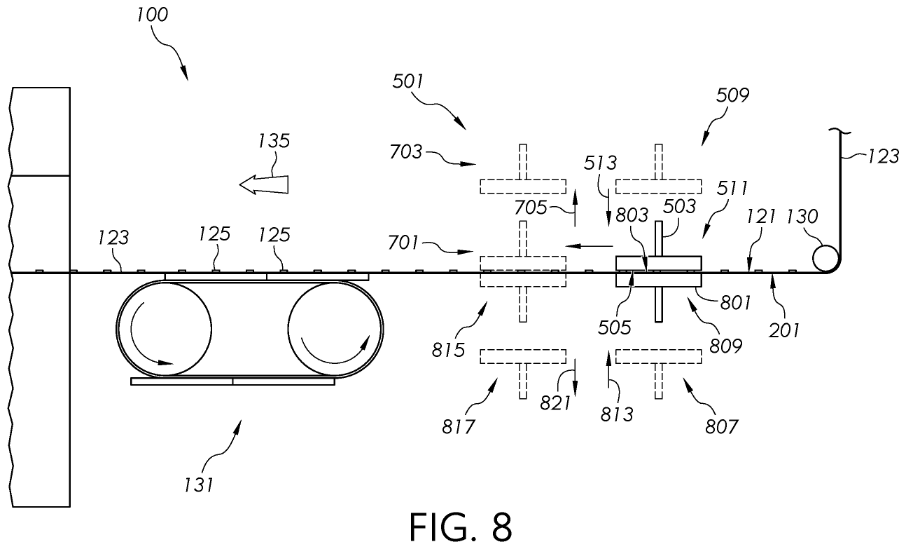

FIG. 8 illustrates a side view of the glass manufacturing apparatus 100 comprising the force application apparatus 501. In aspects, the force application apparatus 501 is not limited to comprising the press 503, but, rather, can comprise a second press 801. The second press 801 may be substantially similar in structure and function to the press 503 illustrated and described relative to FIGS. 5-7. The second press 801 may be substantially similar to the press 503, with the second press 801 positioned on an opposite side of the ribbon 123. For example, the press 503 can be positioned facing the first major surface 121 and the second press 801 can be positioned facing the second major surface 201. The second press 801 can comprise a second press surface 803 that is substantially parallel to the press surface 505. The second press surface 803 can contact a portion of the ribbon 123, for example, the second major surface 201. In aspects, the second press surface 803 can be substantially planar to match the substantially planar shape of the second major surface 201.

The second press 801 can be moved in a first direction 813 from a first position 807 to a second position 809. For example, the second press 801 can initially be in the first position 807, in which the second press surface 803 may be spaced apart from the ribbon 123. The second press 801 can move in the first direction 813, wherein the first direction 813 is substantially perpendicular to the second travel direction 135 and substantially parallel to the first direction 513 of the press 503. By moving in the first direction 813, the second press 801 can move toward the ribbon 123, and may continue to move in the first direction 813 from the first position 807 until the second press 801 contacts the ribbon 123. For example, due to the second press surface 803 comprising a substantially planar shape, the second press surface 803 may contact and support the second major surface 201.

The second press 801 is not limited to moving in the first direction 813. Rather, the second press 801 can move in the second travel direction 135 to accommodate the movement of the ribbon 123. For example, the press 503, the second press 801, and the ribbon 123 can move in the second travel direction 135. In aspects, the press 503 and the second press 801 may contact the ribbon 123 while moving in the second travel direction 135, such that a velocity of the press 503 and the second press 801 may substantially match a velocity of the ribbon 123. The press 503 and the second press 801 may therefore initially contact the ribbon 123 when the press 503 and the second press 801 are in the second position 511, 809. Upon contacting the ribbon 123, the press 503 can be moved from the second position 511 to the third position 701 and the second press 801 can be moved from the second position 809 to a third position 815. The third position 815 may be located downstream from the second position 809, with the second press 801 remaining in contact with the ribbon 123 while moving in the second travel direction 135 from the second position 809 to the third position 815. In aspects, as the press 503 and the second press 801 move in the second travel direction 135, a distance separating the press 503 and the second press 801 (e.g., between the press surfaces 505, 803) may remain the same. By moving in the second travel direction 135, the press 503 can apply the force to flatten and/or planarize portions of the ribbon 123 without stopping movement of the ribbon 123 in the second travel direction 135. Further, the second press 801 can support the ribbon 123 as the ribbon 123 moves in the second travel direction 135. Accordingly, a relative velocity between the press 503, the second press 801, and the ribbon 123 may be about zero.

In aspects, after the second press 801 has moved a predetermined distance from the second position 809 to the third position 815, the second press 801 may be moved out of contact with the ribbon 123. For example, in the third position 815, the second press surface 803 may be in contact with the second major surface 201. The second press 801 can be moved in a second direction 821 that is opposite the first direction 813, with the second direction 821 substantially perpendicular to the second travel direction 135 and away from the ribbon 123. In aspects, the second press 801 can move between the third position 815 and the fourth position 817 along an axis that is substantially perpendicular to the second major surface 201. By moving in the second direction 821, the second press 801 can move out of contact with the ribbon 123, such that the ribbon 123 can continue to move in the second travel direction 135 to the conveyor 131. In aspects, upon reaching the fourth position 817, the second press 801 can return to the first position 807 and begin the operation of contacting the ribbon 123 by moving from the first position 807 to the fourth position 817 again.

In aspects, a position of the press 503 and the second press 801 can be matched. For example, when the press 503 is in the second position 511, the second press 801 may be in the second position 809. Likewise, when the press 503 is in the third position 701, the second press 801 may be in the third position 815. Accordingly, by matching the positions, the press 503 can apply a force to the ribbon 123 while the second press 801 is supporting an opposite side of the ribbon 123. In aspects, the positions of the press 503 and the second press 801 may be substantially the same while being on opposite sides of the ribbon 123. For example, the second positions 511, 809 may be at the same location relative to the second travel direction 135, and the third positions 701, 815 may be at the same location relative to the second travel direction 135.

The glass manufacturing apparatus 100 is not limited to comprising a single second press 801 as illustrated in FIG. 8. Rather, in aspects, the glass manufacturing apparatus 100 can comprise one or more second presses 801 to facilitate supporting the ribbon 123 as the ribbon 123 moves in the second travel direction 135 between the turning roll 130 and the conveyor 131. For example, in aspects, the glass manufacturing apparatus 100 can comprise two second presses 801 that may move from the first position 807 to the fourth position 817. For example, one second press 801 may be in the first position 807 while another second press 801 may be in the third position 815, such that the second presses 801 may not interfere with one another.

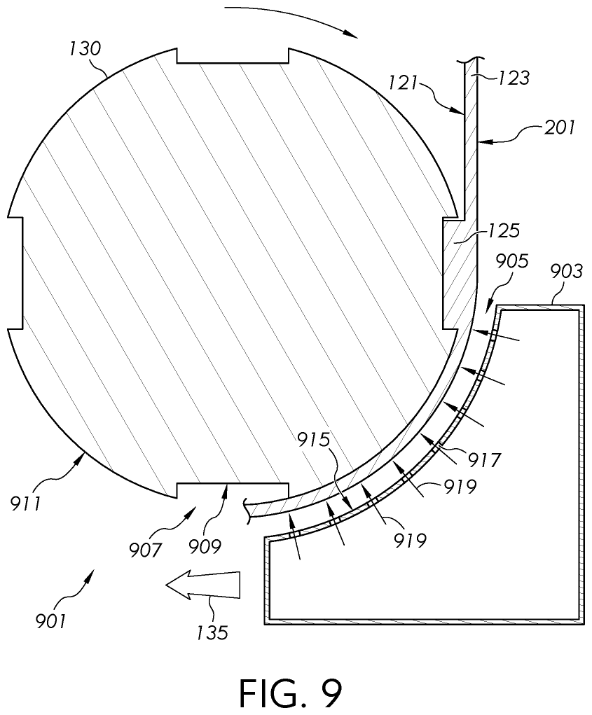

Referring to FIG. 9, the glass manufacturing apparatus 100 can comprise a force application apparatus 901 comprising the turning roll 130 and a body 903. A gap 905 can be formed between the body 903 and the turning roll 130, with the ribbon 123 received within the gap 905. In aspects, the turning roll 130 can be similar in shape to the first forming roll 107 and may comprise one or more recesses 907. The recesses 907 can be formed at an outer surface of the turning roll 130. The recesses 907 can substantially match a size, shape, and location of the protrusions 125 of the ribbon 123. For example, as the ribbon 123 is received within the gap 905, the protrusions 125 can be received within the recesses 907. To facilitate the engagement between the ribbon 123 and the recesses 907, the turning roll 130 can be rotated and synchronized to a speed of the ribbon 123, and spacing between the recesses 907 matches the spacing between the protrusions 125. In aspects in which the protrusion 125 is continuous, the recess 907 can likewise be continuous around the circumference of the turning roll 130 such that synchronization may not be needed.

In aspects, the turning roll 130 can comprise a recess surface 909 that defines the recesses 907, and a roll surface 911 that extends between recesses 907. A radial distance from a center of the turning roll 130 to the recess surface 909 may be less than a radial distance from the center of the turning roll 130 to the roll surface 911. In aspects, to control a temperature of the ribbon 123, the recess surface 909 and the roll surface 911 may be maintained at the same temperature or a different temperature. For example, in aspects, the recess surface 909 may be maintained at a lower temperature than the roll surface 911, such that the recess surface 909 can reduce a temperature of the protrusion 125. The recess surface 909 and the roll surface 911 can be maintained at a desired temperature, for example, by electrical resistance heating, or by forming one or more pockets within the turning roll 130, wherein the pockets may receive a cooling liquid (e.g., water). In aspects, due to the forming process of the ribbon 123, the protrusions 125 may be at a higher temperature than surrounding portions of the ribbon 123. To reduce a temperature difference between the protrusions 125 and surrounding portions of the ribbon 123, the turning roll 130 can cool the protrusions 125, for example, due to the contact between the protrusions 125 and the recess surface 909.

In aspects, portions of the turning roll 130 can be coated with a thermal barrier such that an outer surface of the turning roll 130 may comprise different temperatures. In aspects, the roll surface 911 may be coated with a thermal barrier that has relatively low thermal conductivity and is resistant to temperature changes in the turning roll 130. As such, the thermal barrier that covers the roll surface 911 may be at a different temperature than the recess surface 909, with the recess surface 909 at a lower temperature than the thermal barrier covering the roll surface 911. In aspects, the thermal barrier can comprise one or more of alumina, chromia, a combination of alumina and chromia, 7% Y-zirconia, etc. As such, heat extraction due to the turning roll 130 may be greater at the protrusions 125 than at areas adjacent to the protrusions 125.

To maintain the ribbon 123 in contact with the turning roll 130, the body 903 can apply a force to the ribbon 123 to bias the ribbon 123 toward the turning roll 130. For example, the body 903 may comprise a curved surface 915 spaced apart from the turning roll 130. In aspects, the curved surface 915 can comprise one or more openings 917. A gas 919 can be emitted from the body 903 and through the one or more openings 917, such that the gas 919 can be directed toward the turning roll 130. In this way, the gas 919 can apply a force to the ribbon 123 to bias the ribbon 123 toward the turning roll 130. In aspects, a flow and a temperature of the gas 919 can be regulated to preferentially cool the thicker portions of the ribbon 123. Accordingly, as the ribbon 123 travels through the gap 905 and around the turning roll 130, the ribbon 123 may remain in contact with the turning roll 130 such that contact between the ribbon 123 and the curved surface 915 may be avoided. In aspects, a diameter of the turning roll 130 can be altered, for example, increased, such that the ribbon 123 may spend a longer period of time in contact with the turning roll 130, which can increase the heat extraction from the protrusions 125. Accordingly, as discussed, methods can comprise turning the ribbon 123 around the turning roll 130 after imparting the protrusion 125 and before receiving the ribbon 123 on the surface 133, with the turning roll 130 altering (e.g., heating or cooling) a temperature of the ribbon 123.

In aspects, zero or more of the features illustrated in FIGS. 2-9 may be combined. For example, the turning roll 130 of FIG. 9 may be combined with zero or more of the features of FIGS. 2-8. Likewise, in aspects, the thermal management apparatus 207 of FIG. 2 can be provided with zero or more of the aspects of FIGS. 3-8. Further, the glass manufacturing apparatus 100 of FIGS. 2 and 4-8 is not limited to comprising the conveyor 131, but, rather, may comprise the second conveyor 301 or additional conveyors. Accordingly, while the differing aspects in FIGS. 2-9 are illustrated and discussed in isolation, some or all of the aspects (e.g., the thermal management apparatus 207, the second conveyor 301, the force application apparatus 401 or 501, the turning roll 130, etc.) may be combined.

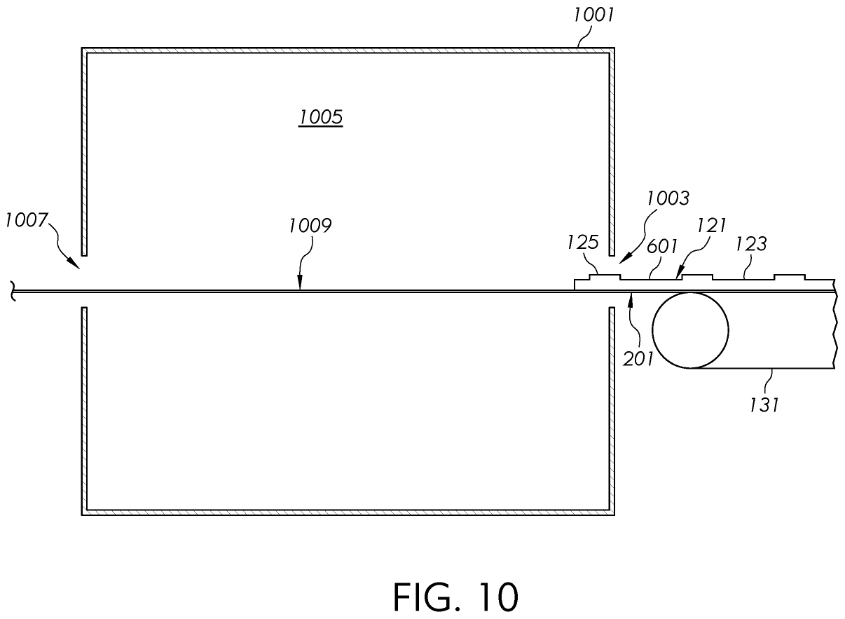

FIG. 10 illustrates a location downstream from the turning roll 130 and the conveyor 131. In aspects, the ribbon 123 can be delivered by the conveyor 131 to a cooling apparatus 1001 (e.g., a controlled cooling apparatus that controls cooling of the ribbon 123). In aspects, the cooling apparatus 1001 can be substantially hollow and may comprise one or more walls. The cooling apparatus 1001 can comprise an inlet 1003 (e.g., an inlet opening formed in a wall) through which the ribbon 123 can be received within the cooling apparatus 1001. The cooling apparatus 1001 can comprise an interior 1005 within which the ribbon 123 can be received after passing through the inlet 1003. For example, the cooling apparatus 1001 can comprise a support surface 1009 positioned within the interior 1005 such that the ribbon 123 can be supported by the support surface 1009. The cooling apparatus 1001 can comprise an exit 1007 (e.g., an exit opening formed in a wall) through which the ribbon 123 can exit the cooling apparatus 1001. In aspects, the interior 1005 of the cooling apparatus 1001 can be maintained at an elevated temperature and can facilitate annealing of the ribbon 123. For example, a temperature of the interior 1005 can be controlled, such that controlled heating and/or cooling of the ribbon 123 can be achieved. This controlled heating and/or cooling can facilitate the formation of a desired stress and warp within the ribbon 123. For example, the ribbon 123 can pass through the inlet 1003 of the cooling apparatus 1001 and may be within the interior 1005 for a period of time. This period of time, along with a temperature rate of change within the interior 1005, can be controlled such that the ribbon 123 can reach an optimal stress upon exiting the cooling apparatus 1001. When the ribbon 123 reaches the optimal stress, successful cutting and/or finishing of the ribbon 123 can occur, with a reduced likelihood of damage to the ribbon 123. In aspects, an optimal cooling profile in the cooling apparatus 1001 can minimize the residual (e.g., or room temperature) stresses in the ribbon 123.

In aspects, methods can comprise reducing a temperature difference between the protrusion 125 and the major surface 121, 201 of the ribbon 123 to less than about 5° C. as the ribbon 123 reaches the inlet 1003 of the cooling apparatus 1001. For example, in aspects, the temperature difference can be calculated as an average temperature of the protrusion 125 subtracted by an average temperature of the base portion 601 of the first major surface 121 that is adjacent to the protrusion 125. In other aspects, the temperature difference can be calculated as a maximum temperature of the protrusion 125 subtracted by a maximum temperature of the base portion 601 of the first major surface 121 that is adjacent to the protrusion 125. In either of these aspects, reducing the temperature difference between the protrusion 125 and the base portion 601 can be achieved in several ways and can yield several benefits. For example, to reduce the temperature difference, in aspects, the protrusion 125 can be cooled by the turning roll 130 (e.g., illustrated and described in FIG. 9). In addition, or in the alternative, the conveyor 131 can comprise the thermal management apparatus 207 that can control the temperature of the ribbon 123 (e.g., illustrated and described in FIG. 2). In addition, or in the alternative, the press 503 can be maintained at a predetermined temperature to change a temperature of the protrusions 125 (e.g., illustrated and described in FIG. 5). Reducing the temperature difference to less than about 5° C. prior to entering the cooling apparatus 1001 is beneficial because a larger temperature differential as the ribbon 123 is cooled within the cooling apparatus 1001 can cause a larger residual stress in the ribbon 123. Accordingly, in aspects, the temperature difference between the protrusion 125 and the base portion 601 can be reduced to less than about 5° C. by one or more of cooling the protrusion 125 or heating the base portion 601 at a location upstream from the cooling apparatus 1001 (e.g., prior to the ribbon 123 entering the cooling apparatus 1001).

In aspects, methods can comprise passing the ribbon 123 through the inlet 1003, with the ribbon 123 comprising an inlet temperature that is below a setting temperature of the ribbon 123 within a range from about 620° C. to about 725° C., or within a range from about 620° C. to about 680° C. The temperature range of about 620° C. to about 725° C. can correspond to a viscosity of the ribbon 123 that is within a range from about 10⁹ poise to about 10¹³ poise, and the temperature range of about 620° C. to about 680° C. can correspond to a viscosity of the ribbon 123 that is within a range from about 10¹¹ poise to about 1013 poise. Accordingly, in aspects, the ribbon 123 can comprise a viscosity (e.g., an inlet viscosity) that is within a range from about 10⁹ poise to about 10¹³ poise as the ribbon 123 passes through the inlet 1003. The inlet temperature can comprise the temperature of the ribbon 123 as the ribbon 123 passes through the inlet 1003. In aspects, the setting temperature of the ribbon 123 can comprise a temperature range, for example, from about 570° C. to about 690° C., and a glass transition temperature of about 620° C. In aspects, at temperatures above the setting temperature range, the ribbon 123 behaves viscously and at temperatures below the setting temperature range, the ribbon 123 behaves elastically.

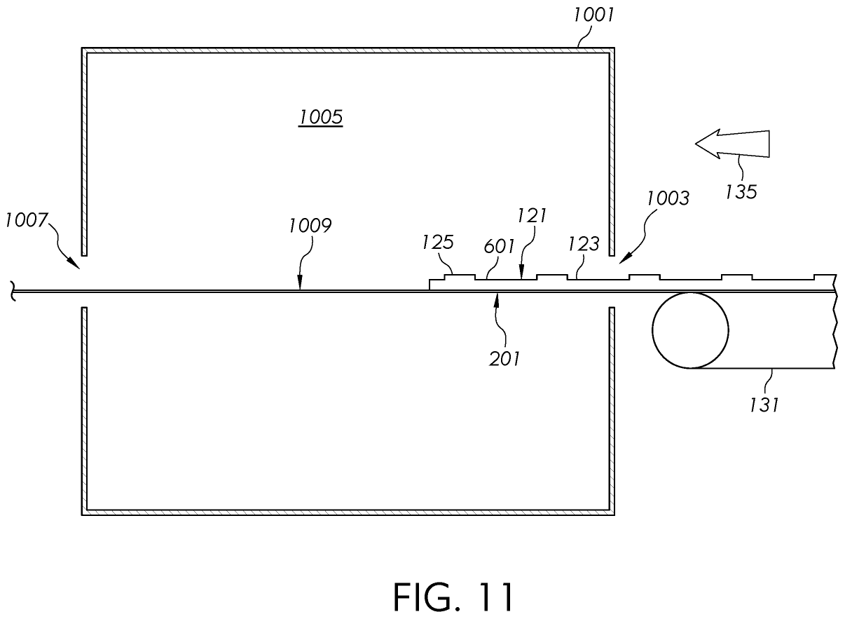

FIG. 11 illustrates a side view of the cooling apparatus 1001 after a period of time has passed and the ribbon 123 has moved in the second travel direction 135 into the interior 1005. In aspects, the ribbon 123 can remain within the interior 1005 for a period of time, for example, within a range from about 20 seconds to about 120 seconds, or from about 40 seconds to about 100 seconds. The temperature within the interior 1005 can be less than a temperature of the ribbon 123, for example, less than about 600° C. or less than about 550° C., or less than about 500° C. In this way, the ribbon 123 can be gradually cooled and may not be exposed to room temperature, which may lead to a greater than desired residual stress. The temperature difference between the protrusion 125 and the base portion 601 can be maintained at less than about 5° C. as the ribbon 123 remains within the interior 1005, thus reducing the stress of the ribbon 123.

In aspects, to maintain the temperature difference between the protrusion 125 and the base portion 601 at less than about 5° C., localized heating and/or cooling of the ribbon 123 within the cooling apparatus 1001 can occur. For example, methods can comprise changing a temperature of the protrusion 125 within the interior 1005 of the cooling apparatus 1001 while maintaining the temperature difference between the protrusion 125 and the surrounding portion (e.g., the base portion 601) of the ribbon 123 to less than about 5° C. The changing of the temperature of the protrusion 125 can comprise applying a localized cooling to the protrusion 125 and not to the base portion 601. The localized cooling can occur, for example, by contacting the protrusion 125 with a cooling surface that is maintained at a desired temperature that is cooler than a temperature of the protrusion 125. In aspects, methods can comprise changing a temperature of the major surface 121, 201 (e.g., the base portion 601) within the interior 1005 of the cooling apparatus 1001 while maintaining the temperature difference between the protrusion 125 and the surrounding portion (e.g., the base portion 601) of the ribbon 123 to less than about 5° C. In aspects, the changing of the temperature of the base portion 601 can comprise applying a localized heating to the base portion 601 to a temperature that reduces the temperature differential. The localized heating can occur, for example, by contacting the base portion 601 with a heating surface that is maintained at a desired temperature that is warmer than a temperature of the base portion 601, or by heating the support surface 1009, which can increase a temperature of the second major surface 201. In aspects, when the temperature difference between the protrusion 125 and the base portion 601 is less than about 5° C. and close to zero when the ribbon 123 enters the cooling apparatus 1001, localized heating or cooling may not be provided. As such, changing the temperature of the protrusion 125 and changing the temperature of the major surface 121, 201 (e.g., the base portion 601) may occur due to the ribbon 123 being exposed to the temperature within the interior 1005.

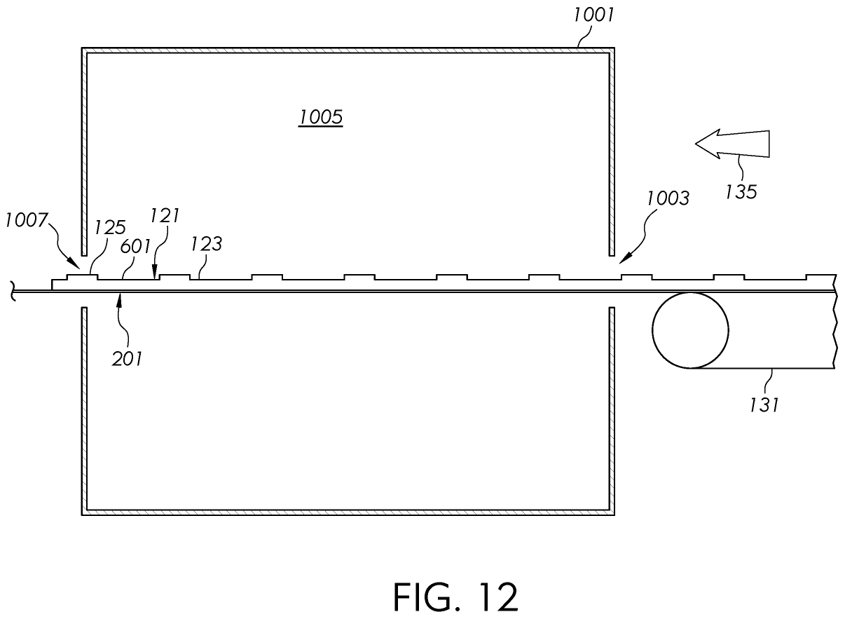

FIG. 12 illustrates a side view of the cooling apparatus 1001 after a period of time has passed and the ribbon 123 has moved in the second travel direction 135 through the exit 1007. In aspects, methods can comprise passing the ribbon 123 through the exit 1007 of the cooling apparatus 1001 such that the ribbon 123 can comprise a temperature upon exiting that is within a range from about 540° C. to about 560° C., or about 0° C. to about 50° C. below a strain point of the ribbon 123, or about 0° C. to about 50° C. below a setting zone of the ribbon 123. In aspects, the ribbon 123 can comprise a viscosity upon exiting the exit 1007 of the cooling apparatus 1001 that is greater than about 10¹⁶ poise. Within these temperature and viscosity ranges, a temperature of the ribbon 123 may be below a setting zone, for example, about 20° C. below the setting zone. By reducing the temperature of the ribbon 123 to be below the setting zone upon exiting the cooling apparatus 1001 (e.g., and maintaining a temperature difference between the protrusion and the base glass of about 5° C.), a stress and a warp of the ribbon 123 may be reduced and minimized. For example, several ribbons 123 were modeled under varying temperature differentials. Several temperature differentials between the protrusion 125 and the base portion 601 were modeled in which the protrusion 125 was at a higher temperature than the base portion 601, ranging from a temperature differential of about 17° C. (e.g, the protrusion 125 being about 17° C. warmer than the base portion 601) to about 70° C. In samples in which the protrusion 125 comprise a first shape (e.g., a square comprising a length and width of about 40 mm), as the temperature differential increased, the stress of the ribbon 123 increased from 12.8 MPa to 24.7 MPa and the warp increased from about 0.091 mm to about 0.161 mm. In samples in which the protrusion 125 comprise a second shape (e.g., an elongated rectangular shape extending across a width of the ribbon 123), as the temperature differential increased, the stress of the ribbon 123 increased from 13.3 MPa to 24.5 MPa and the warp increased from about 0.306 mm to about 0.595 mm. In aspects, when the protrusion 125 and the base portion 601 entered the inlet 1003 at about the same temperature of about 641° C., the stress and warp were the lowest, with a stress of 8.4 MPa and a warp of 0.056 for the first shape, and a stress of 10.2 MPa and a warp of 0.19 for the second shape. Accordingly, as illustrated by these experimental results, reducing a temperature differential between the protrusion 125 and the base portion 601 can provide benefits, for example, a minimized stress and warp.

The aforementioned methods of manufacturing the glass ribbon 123 can yield several benefits. For example, the thermal management apparatus 207 (e.g., illustrated in FIG. 2) can reduce warp of the ribbon 123 and can facilitate control of a temperature of the ribbon 123 prior to the ribbon 123 reaching the cooling apparatus 1001. The second conveyor 301 (e.g., illustrated in FIG. 3) can reduce the degree of bend that the ribbon 123 experiences when the ribbon 123 transitions from moving in the first travel direction 117 to the second travel direction 135, thus reducing the stress that the ribbon 123 experiences and the likelihood of damage to the ribbon 123. The force application apparatus 401 (e.g., illustrated in FIG. 5) can reduce warp of the ribbon 123 and planarize the second major surface 201 prior to the ribbon 123 reaching the cooling apparatus 1001. In aspects, the press 503, 801 (e.g., illustrated in FIGS. 5-8) can planarize the ribbon 123 and reduce thickness differentials within the protrusions 125. Further, the press 503, 801 can change a temperature of portions of the ribbon 123, thus providing localized heating or cooling, which can reduce a temperature differential between the protrusions 125 and the base portion 601 prior to the ribbon 123 reaching the cooling apparatus 1001. The turning roll 130 can further provide temperature control of the ribbon 123, which can reduce the temperature differential between the protrusions 125 and the base portion 601. In addition, the cooling apparatus 1001 can control the rate of temperature change of the ribbon 123, which can reduce stress and warp in the ribbon 123 as the ribbon 123 exits the cooling apparatus 1001 and is exposed to cooler air temperatures. Controlling the stress and warp of the ribbon 123 is beneficial since, after removing the ribbon 123 from the cooling apparatus 1001, a minimal amount of finishing (e.g., grinding, polishing, etc.) to the ribbon 123 may be needed.

It should be understood that while various aspects have been described in detail relative to certain illustrative and specific examples thereof, the present disclosure should not be considered limited to such, as numerous modifications and combinations of the disclosed features are possible without departing from the scope of the following claims.

1. A glass manufacturing apparatus comprising:
a delivery apparatus defining an upstream portion of a ribbon travel path extending in a first travel direction;
a forming roll extending along an axis that is parallel to the travel path and perpendicular to the first travel direction, the forming roll comprising a recess configured to impart a protrusion to a ribbon traveling along the ribbon travel path in the first travel direction;
a substantially planar surface positioned downstream from the forming roll and configured to receive the ribbon;
a conveyor supporting the substantially planar surface, the conveyor configured to move the substantially planar surface in a second travel direction that is angled relative to the first travel direction; and
a force application apparatus configured to bias the ribbon toward the substantially planar surface to alter a position of the protrusion relative to a major surface of the ribbon.

2. The glass manufacturing apparatus of claim 1, wherein the force application apparatus comprises a vacuum apparatus in fluid communication with an opening in the substantially planar surface, the vacuum apparatus configured to evacuate air from the opening.

3. The glass manufacturing apparatus of claim 1, wherein the force application apparatus comprises one or more presses spaced apart from the substantially planar surface to define a gap through which the ribbon travels, the one or more presses configured to move in a direction toward the substantially planar surface and contact the ribbon.

4. The glass manufacturing apparatus of claim 3, wherein the one or more presses are configured to move in the second travel direction at a velocity that is substantially equal to a velocity of the substantially planar surface.

5. The glass manufacturing apparatus of claim 1, wherein the conveyor comprises a second substantially planar surface positioned upstream from the substantially planar surface, the second substantially planar surface forming an angle relative to the substantially planar surface that is within a range from about 135 degrees to about 175 degrees.

6. The glass manufacturing apparatus of claim 1, wherein the conveyor comprises a thermal management apparatus configured to alter a temperature of the substantially planar surface.

7. A method of manufacturing a ribbon comprising:
contacting the ribbon with a recess of a forming roll to impart a protrusion to the ribbon traveling along a ribbon travel path in a first travel direction;
receiving the ribbon on a surface positioned downstream from the forming roll; and then
altering a position of the protrusion relative to a major surface of the ribbon.

8. The method of claim 7, wherein the altering the position comprises forming a vacuum between the ribbon and the surface to bias the ribbon toward the surface.

9. The method of claim 7, wherein the altering the position comprises moving a press in a first direction toward the surface and contacting the ribbon to bias the ribbon toward the surface.

10. The method of claim 9, further comprising moving the press and the ribbon in a second travel direction at a substantially equal velocity.

11. The method of claim 9, further comprising moving a second press in a second direction that is opposite the first direction and contacting the ribbon such that the ribbon is in contact with the press and the second press.

12. The method of claim 7, further comprising activating a thermal management apparatus that controls a temperature of the surface to reduce a temperature of the ribbon as the ribbon is in contact with the surface.

13. The method of claim 7, further comprising turning the ribbon around a turning roll after imparting the protrusion and before receiving the ribbon on the surface, the turning roll altering a temperature of the ribbon.

14. A method of manufacturing a ribbon comprising:
contacting the ribbon with a recess of a forming roll to impart a protrusion to the ribbon traveling along a ribbon travel path in a first travel direction;
reducing a temperature difference between the protrusion and a major surface of the ribbon to less than about 5° C. as the ribbon reaches an inlet of a cooling apparatus;
passing the ribbon through the inlet, the ribbon comprising a viscosity within a range from about 10⁹ poise to about 10¹³ poise;
changing a temperature of the protrusion within an interior of the cooling apparatus while maintaining the temperature difference between the protrusion and the surrounding portion of the ribbon to less than about 5° C.; and
passing the ribbon through an exit of the cooling apparatus, the ribbon comprising a viscosity upon exiting that is greater than about 10¹⁶ poise.

15. The method of claim 14, further comprising changing a temperature of the major surface within the interior of the cooling apparatus while maintaining the temperature difference between the protrusion and the surrounding portion of the ribbon to less than about 5° C.

16. The method of claim 14, wherein the ribbon comprises an inlet temperature that is below a setting temperature of the ribbon and is within a range from about 620° C. to about 725° C.

17. The method of claim 14, wherein the ribbon comprises a temperature upon exiting that is within a range from about 540° C. to about 560° C.

18. The method of claim 14, further comprising:
receiving the ribbon on a surface positioned downstream from the forming roll, the surface moving in a second travel direction that is angled relative to the first travel direction; and
altering a position of the protrusion relative to the major surface of the ribbon.

19. The method of claim 18, wherein the altering the position comprises forming a vacuum between the ribbon and the surface to bias the ribbon toward the surface.

20. The method of claim 18, wherein the altering the position comprises moving a press in a direction toward the surface and contacting the ribbon to bias the ribbon toward the surface.
